(19) United States
(12) Patent Application Publication
(10) Pub. No.: US 2025/0258468 A1
(43) Pub. Date: Aug. 14, 2025

(54) MAXIMIZING RESUABILITY OF METAL CUTTING PROCESS

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/436,164

(22) Filed: Feb. 8, 2024

(51) Int. Cl. G05B 19/04; G05B 23/02

(52) U.S. Cl. CPC G05B 19/041; G05B 23/0213

(57) ABSTRACT

A method, computer system, and a computer program product are provided for re-using of metal by-products prior to fabrication of a main metal product. A plurality of applications are analyzed metal by-products prior to fabrication of the main metal product. The size and quantity requirements of metal products needed for each of the plurality of applications is calculated. It is then determined any fabrication tool required to create the metal by-products. At least one methodology is identified and analyzed that can be used to fabricate the metal by-products for each of plurality of applications. A methodology and related application is selected based on a best match with factors on a preselected objective list. An outline profile is created to be used for fabrication of metal byproducts that includes a plurality of characteristic parameters and a range of acceptable values associated with each parameter.

### BACKGROUND

The present invention relates generally to the field of fabrication of metal parts and more particularly to techniques for maximizing reusability of metal cutting chips.

Metal by-products (hereinafter referenced as metal chips) are created when various metals are processed using cutting or machining processes. These metal chips are often small fragments of bigger metal components and a result of processes that involved the removal of excess material during cutting, milling, turning, or drilling operations. Many of these metal chips carry the characteristics of the parent material, reflecting its composition, mechanical properties, and processing conditions. Ranging in size from fine shavings to larger pieces, metal chips can be made of varied materials that may include steel, aluminum, brass, and the like. While often recycled to recover their valuable metal content, metal chips also find diverse uses beyond recycling. Their potential applications may include acting as filtration media, providing anti-slip surfaces, serving as abrasive materials, and contributing to artistic creations. The handling and management of metal chips play a significant role in maintaining machining efficiency, minimizing waste, and exploring innovative ways to repurpose these fragments in various industrial cutting operation. and creative contexts. Depending on the intended usage, the metal cutting machine should be programmed to produce chips of appropriate lengths, facilitating their direct reuse without further processing.

### SUMMARY

Embodiments of the present invention disclose a method, computer system, and a computer program product for re-using of metal by-products prior to fabrication of a main metal product. In one embodiment, a plurality of applications are analyzed for metal by-products prior to fabrication of the main metal product. The analysis includes determining characteristic of the main metal product. The size and quantity requirements of metal products needed for each of the plurality of applications is then calculated. It is then determined any fabrication tool required to create the metal by-products. At least one methodology is identified and analyzed that can be used to fabricate the metal by-products for each of plurality of applications. A methodology and related application from amongst a plurality of methodologies and applications based on the analysis and determining which of the plurality of applications best matches with factors on a preselected objective list. An outline profile is then created to be used for fabrication of the metal byproducts, wherein the outline profile includes a plurality of characteristic parameters and a range of acceptable values associated with each of the parameters the metal by-products.

In another embodiment, the outline profile is obtained then subsequently used to fabricate metal by-products in form of metal chips. The methodology selected is analyzed for the fabrication steps to be performed and a plurality of checkpoints are established. The checkpoints are used for monitoring the quality of the metal chips during the fabrication process. At each checkpoint, at least a portion of the metal chips are selected and these metal chips are measured for certain parameter values. These values are then compared to the values of a plurality of parameters provided in the outline profile. The values are then compared and when the values measured fail to meet the parameter values provided in the outline profile, those chips that have failed the comparison are removed. The AI then determines possible reasons for the failure and adjusts the tools or the fabrication process to fabricate new chips. The process is reiterative and is repeated until new chips that do not fail the comparison are fabricated in the quantity that is indicated in the outline profile.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for a process involving re-usability of metal by-products, according to one embodiment;

FIG. 3 provides a graphical example of metal chip characteristic used for process optimization, according to one embodiment;

FIG. 4 provides an example of various metal cuts and shapes for selecting optimized sizes for fabrication of metal chips, according to one embodiment;

FIG. 5 is an example providing impact of size and cutting methodology on metal chip characteristics, according to one embodiment; and

FIG. 6 provides a flowchart depiction of a method for fabrication of metal chips, according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

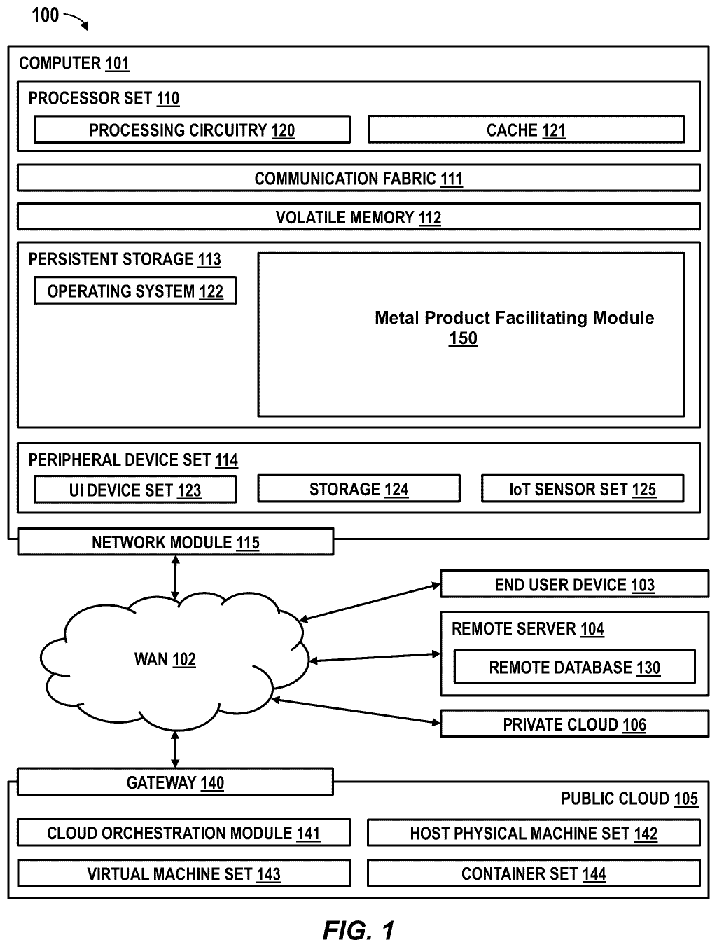

FIG. 1 provides a block diagram of a computing environment 100. The computing environment 100 contains an example of an environment for the execution of at least some of the computer code involved in performing the inventive methods, such as code change differentiator which is capable of providing a Metal Product Facilitating Module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

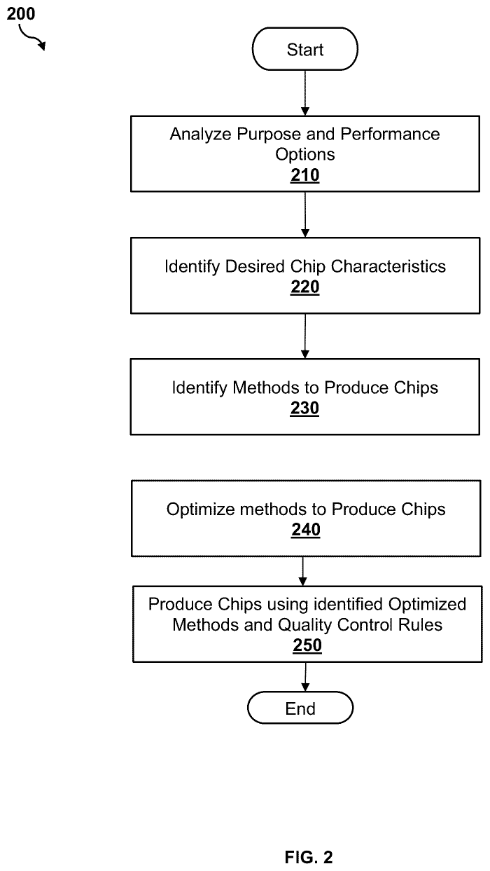

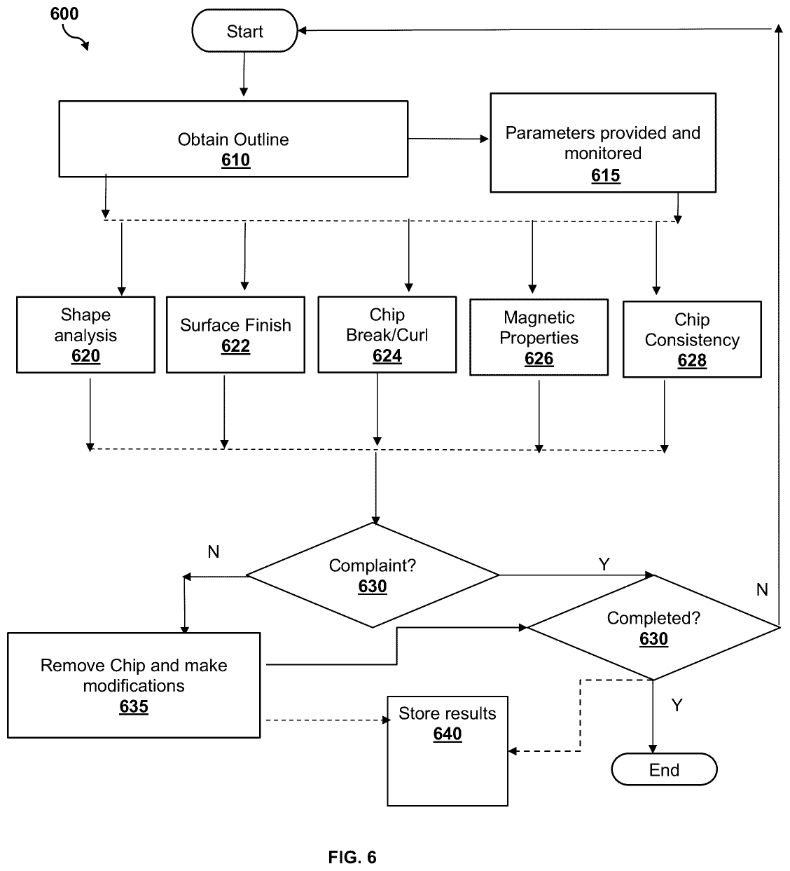

During metal cutting machining, metal cutting tools generate metal by-products hereinafter referenced as metal chips. Apart from recycling these chips, they can also find reuse in their original form with suitable shapes and dimensions. For instance, if decorative items are being crafted, the required length of metal chips can be determined based on the design of the decorative object. Similarly, if the metal chips are intended for abrasive blasting, smaller dimensions are needed. Depending on the intended usage, the metal cutting machine should be programmed to produce chips of appropriate lengths, facilitating their direct reuse without further processing. FIG. 2 provides a flowchart depiction of a process 200 of cutting metals using techniques where the remaining parts, herein referenced as metal chips, can be reused efficiently and sustainably for other processes. In one embodiment, one or more computer systems such as that discussed in FIG. 1 (more specifically metal product facilitating module 150) may be used to generate the cutting and production of the metal chips efficiently in a manner wherein later usability is maximized. In addition a self-learning Artificial Intelligence (AI) engine can be used to automate the process 200 (and process 600 in FIG. 6).

As previously discussed, during metal cutting machining, metal cutting tools generate metal chips. This metal cutting by-products or metal chips can be used in a variety of ways. One obvious use will be recycling these chips for other processes. These chips can be reused in their original form with suitable shapes and dimensions or used in processes that reshape them entirely. For instance, if decorative items are being crafted, the required length of metal chips can be determined based on the design of the decorative object. Similarly, if the metal chips are intended for abrasive blasting, smaller dimensions are needed. Depending on the intended usage, the metal cutting machine should be programmed to produce chips of appropriate lengths, facilitating their direct reuse without further processing.

Process 200 can use a variety of tools and metal cutting machines such as lathes and drills to assist and accommodate any requirements for direct reusability of metal chips generated during the cutting process. A metal chip separation system, integrated with the metal cutting machine, can also be used to measure the necessary length of the metal chips on real time and dynamic basis these can be trimmed during the metal cutting operation). In one embodiment, this ensures that the metal chips can subsequently be directly reused in their original form. The steps as discussed below can be performed by the module 150 as discussed in FIG. 1. In one embodiment, a self-learning artificial intelligence (AI) engine can be used to perform part or all of the steps as will be discussed below.

In Step 210, requirement analysis is performed. This analysis is based on obtaining information from one or more sources that are submitted by a user, a job specification, a database, on-line sources or a combination of these. Information gathered from these sources can include a variety of components such as reviewing need for using a specific application or purpose for which the metal chips are needed. In one embodiment, the analysis may also involve considering different properties of the material types involved in the process including but not limited to the properties of the metal chips (such as steel, aluminum, copper etc.), extent of material purity, the size and shape of the original material and the subsequent desired chips as well as material characteristics (thermal and electrical conductivity, corrosion and chemical resistance etc.

Information may also be received about historical knowledge (from a corpus) on what types of cutting parameters are to be selected for different types of chip formation and associated cutting time and productivity without compromising he quality of work product. Information about raw material and were the work product is to be manufactured (how to acquire the resource) may also be obtained or provide.

In one embodiment, the analysis includes determining which type of metals can be obtained and then which one of them best suits the application requirements. Again, a variety of factors are considered including mechanical properties, thermal conductivity, electrical conductivity, and chemical resistance. The purpose of the analysis is to be able to obtain the requirement specification of the metal chips to be produced or generated, such as during a cutting process and align the in the subsequent steps with a work product specification essential for ensuring that the produced metal chips meet a desired quality and characteristic. The initial analysis step may also identify general inefficiencies, bottlenecks or possible issues leading to quality control.

Looking at process 200, in Step 220, based on the result of the analysis in step 210, characteristics about the subsequently metal chips are identified and possible materials that can be obtained (reused, generated, ordered, etc.) are analyzed. In one embodiment, this may include identifying types of products and/or services where metal chips are subsequently required. In one embodiment, this includes obtaining and receiving the quality and quantity criteria of the metal chips such as one or more characteristics of the materials such as material strength, curvature profile, the desired size range of the chips (from fine powders to larger chunks) and the like depending on the application. This determination, in one embodiment, can also lead to analysis and a preliminary consideration of any particular metal cutting techniques and tools to achieve the final metal chip product that meets the desired length, material, volume and amount (number) of the metal chips to be produced.

In Step 230, the method for ultimately providing the metal chips are generated. This can include a variety of different aspects such as identification and matching of a particular machine that can generate the desired product. In one embodiment, a number of available machines that can be used for used for generating the metal chips. In one embodiment, the metal cutting machines compare the pattern of chip generation with the specifications for reusing the metal chips. Subsequently, a chip separation system and robotic system will be employed to trim the metal chips with a particular or required specification

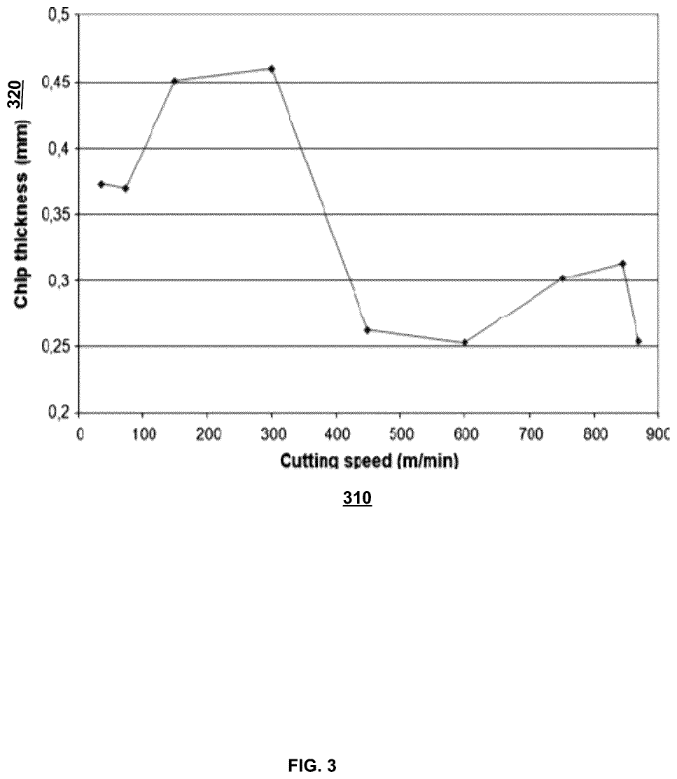

In addition, in one embodiment, the determination of methodology may also include manufacturing and quality control steps to achieve the desired results. This aspect is later discussed in more detail. Other aspects such as cutting speed, incorporation of other materials and providing final quality control with respect to tolerances and surface finish and other relevant attributes may also be provided. FIG. 3 provides an example of this concept, where the cutting speed 310 and chip thickness 320 are analyzed to provide optimal ranges.

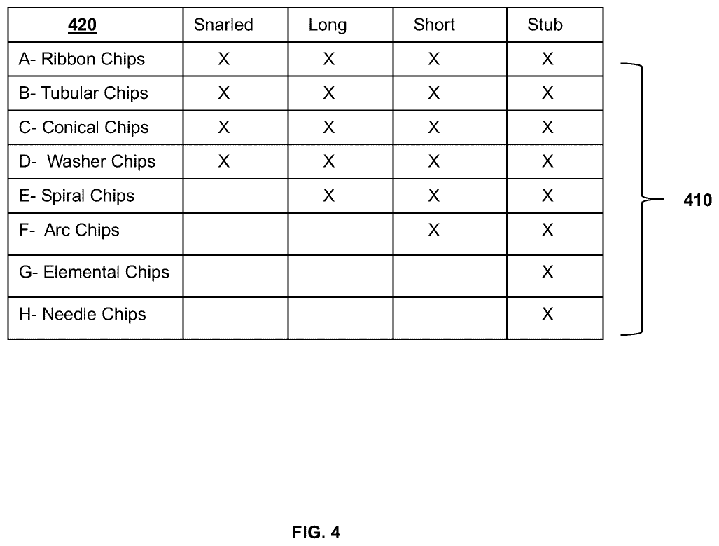

In one embodiment, data may be retried from one or mor sources including cloud based, online or other databases including historical data. In this scenario, based on the historical learning about the chip formation pattern (using AI as appropriate) with respect to cutting parameter, the process 200 (AI etc.) will select appropriate cutting parameters. These may include cutting speed, feed rate, tool geometry, coolant/lubrication, and material being cut. These parameters significantly influence chip formation and quality. In one embodiment, a knowledge corpus can be also created to include these types of historical data. Process 200 (or AI) can then identify the chips formation patterns based on various cutting parameters. An example of this is provided in FIG. 4.

In FIG. 4 provides a table showing different types of cuts from different cutting machines is provided resulting in different metal chip characteristics. The kind of chip shape is provided in column 420. The chip types A through H provide different characteristic shapes such as ribbon, tubular, conical, needle and the like as shown. The rows 410 provide the possibility of different metal chip lengths such as snarled, long, short and stub for example. As can be viewed, not every type of length can be provided with every cut. For example, a snarled or long length is possible with ribbon type (type A) and conical (type C) chips but will not be possible for needle or arch type chips (type F and H).

Returning back to process 200, in Step 240, the methodology of step 230 as generated may be further reviewed and optimized. This can include optimizing a variety of the characteristics such as metal cutting parameters or substituting elements or materials to increase the reusability of the chips. In one embodiment, this can include many components and data gathering and initial analysis of manufacturing conditions is a factor. Other factors may depend on a systemic approach of balancing any of coexisting factors such as efficiency, quality, resource utilization and sustainability. In the example of FIG. 4, in a scenario where a long chip is desired a methodology is used that produces ribbon chips, tubular chips, conical chips, washer chips and spiral chips (types A-E) but no tone that produces arc, elemental or needle chips (type F-H).

The methodology and/or types of chips and their chosen material can be obtained from a variety of sources including a required specification. For example, the use can be that of a filtration media where metal chips are intended to be used as a filtration medium in applications such as wastewater treatment, where they can capture suspended solids and contaminants from liquids. The materials selected for these may be required to be of a certain dimension and be optimally (Step 250) selected to reflect sustainability and environmental factors. In a different application, anti-slip surfaces may be of main concern. In such a case the metal chips have to be mixed with epoxy or other binding agents to create anti-slip surfaces for walkways, stairs, or industrial flooring. In yet another use, chips have to be of such a quality and quantity that they can be used for abrasive blasting to remove paint, rust, or other coatings from surfaces. The chips may even be intended to be produced to be incorporated into purely artistic or decorative items such as sculptures, jewelry, or crafts.

The materials can also be dependent on the use. For example, in certain manufacturing processes, metal chips can be used as reinforcement to enhance mechanical properties, such as using steel chips as a partial replacement for sand in concrete. In addition, metal chips such as steel chips can also be used to add weight to products to improve stability and to increase density (again in many concrete applications). Metal chips can also be used in other different applications such as sound dampening to soundproof or dampen noise (particularly in industrial settings). They can also be used as construction fillers in construction projects such as road construction. Metal chips can also be used effectively for corrosion control. For example, when used in cathodic protection systems, metal chips may prevent corrosion of metal structures by acting as sacrificial anodes.

In Step 240, is optimized. For example, the methodology of Step 230 can select more than one material and/or process to create a desired result. However, when two methodology can be used, an optimization step may select one that has multiple purposes over one that only can be used once. Even when two methods have similar results, the chips that can be used for treating wastewater or other environmental issues may be selected. In one embodiment, the process may even set out predefined KPIs and have an associated score such as a sustainability score. The objective when comparing methodologies is to increase certain goals like reusability, profitability, manufacturing time etc. Some other goals for optimization may be increasing productivity, improving chip reusability, minimizing tool wear and maintaining quality. For example, the optimization may be to enhance manufacturing productivity and increase reusability of chips using a systemic approach that balances efficiency. Quality na resource utilization and sustainability. Comprehensive data has already been collected including material properties, tooling, machine specification and existing cutting parameters, and quality. The initial analysis has identified general inefficiencies, bottlenecks or possible issues leading to quality control. The optimization step may further identify key cutting parameters such as cutting speed, feed rate, depth of cut and coolant and lubrication usage. It also will analyze how changes to these parameters impact chip formation, tool life, surface finish and other relevant factors. There may even be an evaluation of productivity of the work product and also the reusability of chip formation.

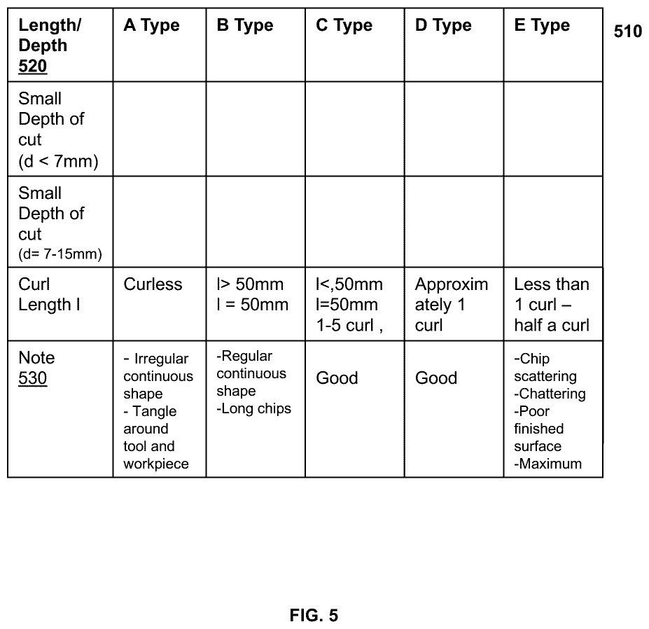

FIG. 5 provides a table that can be used in steps 240 and 250 to select methodology and optimized the methods of producing different metal chips. The desired characteristics of the final product can help select the methods of cutting and/or refinement of the chips in this scenario. Similar to the example of FIG. 4, a variety of chip types A through E are provided as shown by row 510 as enumerated. The length and depth are shown in column 520 and particular notes about each type is also provided in row 530. Other factors can also be used for optimization but the example provided in FIGS. 5 and 4 are one scenario where characteristics of the final products can be selected and optimized for a desired result. For example, while E type material provides a small (less than 1) curl structure as may have been provided by FIG. 4 due to materials and the size, the other factors provided in the note column such as chip scattering and chattering will not lead to optimize results.

Returning to FIG. 2, Step 250 is the fabrication or production process that generates the chips. This includes manufacturing or generating the chips but also involves an element of controlling the process and the overall quality control. In one embodiment, prior to actual production commences, an outline of the specification and requirements for the final work product will incorporate metal chips which includes dimensions, material properties, tolerances, surface finish and other relevant attributes. This outline can then be incorporated into the process 600 of FIG. 6 to ensure the correct production of the chips (quality control of the process).

In summary, the process 200 the best optimized method is identified based on metal chip requirements provided for a particular purpose (or several) based on at least a specification. The metal chips characteristics have been identified for a desired result. This can include material type (e.g., steel, aluminum, copper), size, shape, purity, mechanical and thermal properties, chemical resistance and any special characteristics (e.g., thermal/electrical conductivity, corrosion resistance). Based on the specification and the analysis requirement the quantity and desired size range is also determine. This could range from fine powders to larger chunks, depending on the application. Based on identified types of products to be manufactured, services where metal chips are required, the proposed system will be receiving the quality criteria of the metal chips, like strength, curvature profile and the like. These will then be obtained/acquired to complete the product manufacturing of Step 250.

In one embodiment, the manufacturing metal chips in Step 250 can use conventional methods or it can take advantage of automated systems (robotic systems and AI) for product generation as well as quality control and monitoring. For example, a metal chip separation system can be automatically integrated with the with the metal cutting machine. The AI or other automated measuring components can measure the necessary length of the metal chips on real-time basis and trim them during the metal cutting operation. This ensures that the metal chips can subsequently be directly reused in their original form. In one embodiment, the identified parameters as required by the specification (metal chip length, volume, etc.) is monitored and the metal cutting machines will compare the pattern of chip generation with the specifications for reusing the metal chips and accordingly chip separation system and robotic system will be employed to trim the metal chips with required specification.

In one embodiment, during the manufacturing system AI or automated systems can dynamically control the chip separation and robotic chip removal systems for managing the metal chips parameters. This approach ensures that the manufactured metal chips are suitable for direct reuse without necessitating additional processing, Furthermore, in one embodiment during the metal cutting process, the chip separation and chip removal robotic arm will generate and arrange multiple types of chips based on the material being worked on. In such cases, for example, a robotic arm may be used to carefully position the generated chips in their respective segmented areas. This is to prevent a need for additional isolation of the produced metal chips. In addition, the optimization information may be used to alteration of metal chips with required specification and the work product) time. This is because optimization step and quality control features when the tools (cutting tool etc.) need replacing dynamically.

In one embodiment, the manufacturing of the product involves monitoring and quality control throughout the process. In one embodiment, checkpoints are established to ensure the metal chips are produced as per required for the application. This process is captured in FIG. 6. Process 600 in FIG. 6 can use metal cutting machines such as lathes and drills to accommodate the usability requirements as provided by process 200 of FIG. 2.

FIG. 6 provides a flowchart illustration of the process 600 which complements Step 250 (and process 200) and follows the outline provided. Process 600 is deemed to monitor the production of the chips as provided by process 200 and ensure the quality throughout the manufacturing process.

In Step 610, the enumerated outline is obtained, and chip cutting conditions are analyzed. The outline will provide the key performance indicators (KPIs) as identified for monitoring during the manufacturing process. In addition, information about the raw materials (where and in what condition and from what resources they can be received) are provided. In one embodiment, this can include also obtaining the requirement specification and information about the type and quantity of the chips to be manufactured and other information related to the tools instead of the chips such as tool wear criteria, cutting forces and energy consumption.

In one embodiment, as appropriate historical knowledge of parameters can also be received. In addition, the outline may incorporate cutting conditions as evaluated against the specified parameters as provided by process 200. These cutting parameters and the machine is checked to ensure that they are conducive to metal chip production in a way that is aligned with the desired specifications. In one embodiment, this also includes real-time monitoring of chip formation. For example, during the cutting process a control system will perform close monitoring of the formation and checks the characteristics (size, shape, quality etc.) as compared to the specification. Visual inspection, such as performed by an AI or other methods involving cameras etc. can be incorporated to also measure the tools and cutting machines to verify chip production. Optimum cutting parameters for required types of chip formation is also provided. Image analysis using these sensors and cameras will be able to detect size, shape, and quality of generated chips to a great degree. Sensor and camera data will be processed and analyzed in real- time suing one or more image processing algorithms and machine learning techniques, especially when an AI engine is being used. Throughout the process chip characteristics will b compared with the reference models to determine if they meet the requirement specification.

In Step 615, based on optimization model, appropriate cutting parameters are selected to be monitored at different work product manufacturing junctions throughout the process. The monitoring can be performed in a variety of ways. For example, a robotic arm can be used incorporated into the cutting machine which will have chip trimming and chip removal (robotic arm). One or more sensors can be incorporated to obtained data during different checkpoints. The sensors can be varied ranging from cameras and force sensors to acoustic sensors.

These parameters and checkpoints are method and optimization dependent and can vary from application to application. For ease of understanding some factors 620-628 are shown in this example with the understanding that they can change in alternate embodiments.

The monitoring can be performed in a variety of ways. For example, a robotic arm can be used incorporated into the cutting machine which will have chip trimming and chip removal (robotic arm). One or more sensors can be incorporated to obtained data during different checkpoints. The sensors can be varied ranging from cameras and force sensors to acoustic sensors.

In this example the size and shape analysis is one factor as shown at 620. This will measure the dimension of a sample of metal chips being produced with as with an automated measuring equipment. The measurement may be compared to the desired specification and inconsistent sizes or irregular shapes can suggest that the cutting tool wear or improper settings have been made and a readjustment is needed.

In Step 622 the surface finish is also assessed such as with a lens (such as a microscope) or surface finish equipment to analyze surface quality of the chips. A sample may be selected from the chips to assess if they are smooth and their surface is uniform. Proper finish can indicate proper cutting conditions while rough surfaces can signal tool wear of inadequate lubrication.

In Step 624, chip breakage and curling is also measured. While some breakage may be normal or expected. Excessive breakage or curling can indicate improper feed rates or tool geometry that is inappropriate. Well formed chips are also less likely to cause further tool wear and machine damage.

In Step 626, magnetic properties may be another factor that requires monitoring. Magnetic chips with magnetic properties can indicate presence of ferrous metals while those with no magnetic properties suggest lack or presence of non-ferrous metals. This can be important wen materials used for the chip formation requires ferrous or non-ferrous components.

In Step 628, the overall chip consistency is evaluated. The formation of metal chips may be monitored during different points in the cutting process. Checking the chip quality during different points of eh process also ensures that the quality remains consistent throughout the operation. Inconsistent chip quality could indicate a variety of different factors such as tool wear or unstable cutting conditions.

As shown in the decision block 630, when the monitoring system identifies that the metal chips do not meet the required specification, using different measuring criteria as shown at 620-628, the cutting parameters are adjusted and the chips removed accordingly as shown at 635. This may be different for each case. For example, process may modify the cutting speed, feed rate, tool geometry or the like to optimize and adjust the quality of the chips during their formation.

Non complaint chips, in one embodiment, are removed or altered such as by trimming etc. This can be accomplished in a number of ways as appreciated by those skilled in the art. For example, a chip trimmer and robotic arm can collaborate when the portion of any chip is aligned to send a signal to a chip separation and trimmer system to remove the chip. The chip trimmer is responsible for positioning itself appropriately for chip removal. In one embodiment, the robotic arm can be programmed to move the identified chip location and adjust its position and orientation for optimal chip removal.

In a different embodiment, the robotic arm can cause chip removal. In this case the robotic arm deploys appropriate tools (such as grippers) to securely grasp the non-compliant chip. A chip trimmer can be used to provide support by stabilizing the work area and ensuring safe chip removal. The robotic arm and the chip trimmer, in this scenario, work collaboratively to safely and efficiently remove the non-compliant chip from the cutting area.

Step 640 can be optionally added. In Step 640, data relating to quality control and monitoring is collected and any required modification and reason for it (cutting speed alteration, tool wear etc.) is also recorded. The information is stored in a database to provide historical learning, especially for a self learning AI engine. This will allow subsequent statistical methods to identify significant factors and interactions influencing productivity and chip reusability. This can also help identify optimal parameter settings that balance multiple objectives dynamically and for later use.

Step 650 monitors process completion and stops the monitoring of checkpoints when all required chips have been manufactured. Additional steps like packaging or delivery options can be added to this step.

It should be noted that chip formation dynamics can be calculated and controlled through a variety of methods. In one embodiment, during metal cutting, there are at least three main type of chip formation dynamics as provided below:
1) Continuous Chip Formation-Continuous chips are long, ribbon-like structures that form during machining. Their Characteristics: Smooth and continuous, indicating steady and uniform cutting conditions. Factors: Common in ductile materials and high cutting speeds.
2) Serrated Chip Formation (Segmented or Built-Up Edge Chip)-these chips have a series of short segments separated by built-up edges. Their Characteristics: Irregular, with interruptions, indicating fluctuations in cutting conditions. Factors: Common in materials with varying hardness, low cutting speeds, or inadequate tool geometry.
3) Discontinuous Chip Formation-also known as segmented chips, they are short, broken pieces. Characteristics: Breakage occurs at regular intervals, resulting in smaller chip segments. Factors: Common in brittle materials, low cutting speeds, or when using cutting tools with high positive rake angles.

The type of chip formed depends on factors such as cutting speed, feed rate, depth of cut, material properties, and tool geometry. Each type of chip formation has implications for the machining process, affecting factors like tool wear, surface finish, and overall efficiency. Some of the more common cutting models are enumerated here for ease of understanding. In alternate embodiments, other models are also available.
1. Orthogonal Cutting Model: The orthogonal cutting model is a fundamental

representation of metal cutting. It involves a cutting tool moving along the workpiece at a right angle. Mathematical formulations include Taylor's equation for chip thickness, which relates cutting speed (V), feed (f), and the undeformed chip thickness (t0t0):

$${t}_{0} = ( V {t}_{c} ) / f$$

2. Shear Plane Angle: The shear plane angle (ϕ) is the angle between the shear plane and the normal to the cutting direction. It is a crucial parameter in metal cutting models. Mathematical expressions depend on the cutting conditions and material properties.
3. Heat Generation: Heat is generated during metal 1 cutting due to the deformation of the work material. The heat generated (Q) can be estimated using various models, such as the Oxley model. The Oxley model includes parameters like cutting speed, chip thickness, and specific energy.
4. Chip Formation: Chip formation involves the creation of metal chips during cutting. Different types of chips, such as continuous, discontinuous, and segmented, can be formed based on cutting conditions. The type of chip and its specifications (thickness, length) depend on factors like cutting speed, feed, and tool geometry.

Chip Thickness Ration (Rake Angle): The chip thickness ratio (r) is related to the rake angle of the cutting tool. It influences chip formation and cutting forces.

$$r = ( {t}_{c} - {t}_{0} ) / {t}_{c}$$

The relationships between cutting speed (V), feed rate (f), depth of cut (d), material properties, and tool geometry in metal cutting are complex and depend on various factors. However, the basic formula for calculating cutting speed is the widely used Speed-Feed-Depth of Cut formula:

V=f×N

### Where:

V is the cutting speed (in meters per minute or feet per minute),
f is the feed rate (in millimeters per tooth or inches per tooth),
N is the rotational speed of the cutting tool (in revolutions per minute).
   For determining the material removal rate (MRR),

MRR=V×f×d

### Where:

MRR is the material removal rate (in cubic inches per minute or cubic millimeters per minute),
V is the cutting speed,
f is the feed rate,
d is the depth of cut.

In this case, cutting speed is depends on the rotational speed of the work product on the machine, and the diameter of the work material, the diameter of the work material can be changed during metal cutting operation, and the cutting speed will also be reduced. If the rotational speed is (ω), and the diameter of the work material at the cutting point is (D) then the cutting speed V=ω×(D/2); So the material removal rate is MRR=ω×(D/2)×f×d.

In one embodiment, the process will identify the specification of the chip requirement, like length, thickness, so, invention will evaluate the change if material removal rate, and will perform cost benefit analysis. Based on a cost benefit analysis, invention will identify the rate of material removal, and will generate the material chips align with the metal cutting requirement. And based on the specification of the chips, the invention will calculate the material removal rate, and will be engaging the robotic system to trim the chip at the current location. Chips generated during metal cutting operations may be considered as scrap and require additional manufacturing processes to convert the same to raw materials. The process provided herein will consider the chips as byproducts that will be provided alongside the main work product being produced so there is not additional overhead or additional processing steps while minimizing waste.

AI and other algorithms can also be used to provide exact and ahead of time calculations during the analysis and model selection. The following example selected during optimization can ease understanding. In this example, the methodology is to provide sustainable scheduling of metal cutting processes and is divided into different components of production time consideration, carbon footprints considerations and provides a downstream re-use score.

There a variety of parameters, namely:
n—total number of metal cutting jobs;
m—total number of machines to be used;
nᵢ—total number for processes of job i for re-use
tᵢⱼₖ—processing time of kth operation of job i.
Decision Variables: Cⱼₖₛ—completion time slot of Oᵢₖ and
Xᵢₖⱼₛ—machine “j” is selected for Oᵢₖ
   It should be noted that for I, h metal cutting job index—i, h=1,2, . . . n; each job I consists of ni process (Oi1,Oi2 . . . Oini); j machine index j=1, 2, . . . m; k an dg—sub operation jobs are k,g-=1, 2, . . . ni; F_{CS}—carbon footprint of electronic gid for time slot S=1 . . . T and C_{fc} is the weighting factor for carbon footprint of electric grid. The formula then becomes:

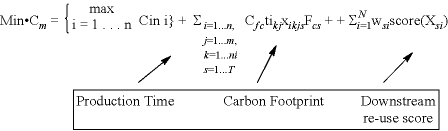

The following two equations can also represent the operating job sequence constraint:

$${c}_{ik} - {c}_{i ( k - 1 )} \geq {t}_{ikj} {x}_{ikj} , k = 2 , … , ni , ∀ i , j$$

$$[ ( {c}_{hg} - {c}_{ik} - {t}_{hgj} ) \geq 0 ] ∨ [ ( {c}_{ik} - {c}_{hg} - {t}_{ikj} ) {x}_{ijk} \geq 0 , ∀ i , j , g , h$$

The following equation guarantees machine allocation that for each operation can only process on one machine from a given set at one time; and

Σ_{xikj∈Aik}xikj=1, ∀i, j,g,h

The following two operations provide non-negative or 0-1 binary variable which are restrictions on decision variables:

cᵢₖ≥0, ∀i, i,k

xᵢₖₕ∈{0,1}∀i, j,g,h

FIG. 2 provide a process for determining and selecting an optimized methodology for reusing metal by-products, according to one embodiment and FIG. 6 provides a process of manufacturing these metal by-products (metal chips) using the parameters and methodology discussed in conjunction with FIG. 2. Embodiments provided by FIG. 2 provide a process to select an optimized application for by-products created during the fabrication of a main metal product. In one embodiment, a plurality of applications are analyzed for metal by-products prior to fabrication of the main metal product. The analysis includes determining characteristic of the main metal product. The size and quantity requirements of metal products needed for each of the plurality of applications is then calculated. It is then determined any fabrication tool required to create the metal by-products. At least one methodology is identified and analyzed that can be used to fabricate the metal by-products for each of plurality of applications. A methodology and related application from amongst a plurality of methodologies and applications based on the analysis and determining which of the plurality of applications best matches with factors on a preselected objective list. An outline profile is then created to be used for fabrication of the metal byproducts, wherein the outline profile includes a plurality of characteristic parameters and a range of acceptable values associated with each of the parameters the the metal by-products.

In embodiment of FIG. 6, the outline profile is obtained then subsequently used to fabricate metal by-products in form of metal chips. The methodology selected is analyzed for the fabrication steps to be performed and a plurality of checkpoints are established. The checkpoints are used for monitoring the quality of the metal chips during the fabrication process. At each checkpoint, at least a portion of the metal chips are selected and these metal chips are measured for certain parameter values. These values are then compared to the values of a plurality of parameters provided in the outline profile. The values are then compared and when the values measured fail to meet the parameter values provided in the outline profile, those chips that have failed the comparison are removed. The AI then determines possible reasons for the failure and adjusts the tools or the fabrication process to fabricate new chips. The process is reiterative and is repeated until new chips that do not fail the comparison are fabricated in the quantity that is indicated in the outline profile.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for re-use of metal by-products prior to fabrication of a main metal product, comprising:
determining a plurality of applications that can be used to manufacture a plurality of metal by-products as part of fabrication of said main metal product;
calculating a size and a quantity of metal by-products needed for each of said plurality of applications and determining at least one fabrication tool needed for their manufacturing;
identifying at least one methodology to be used to fabricate said plurality of metal by-products for each of said plurality of applications based on said size, said quantity and said at least one fabrication tool;
selecting a methodology and related application from a plurality of methodologies and applications identified based on a measure of adherence to factors on a preselected objective list; and
creating an outline profile to be used for fabrication of said metal byproducts based on methodology selected and quantity and size of said metal by-products.

2. The method of claim 1, wherein said method to for re-using metal by-products is performed by a self-learning Artificial Intelligence (AI) engine.

3. The method of claim 2, wherein said method selected is analyzed by said AI engine by further analyzing cost effectiveness and fabrication time for each method amongst said plurality of applications and a method is selected that optimizes cost effectiveness with fabrication time.

4. The method of claim 1, wherein said metal by-products are a plurality of metal chips and said outline profile is stored in a database.

5. The method of claim 1, wherein said outline profile includes a plurality of characteristic parameters and a range of acceptable values associated with each of said parameters for said metal by-products.

6. The method of claim 5, wherein said outline profile also includes at least one parameter value relating to at least one of size, curvature, dimensions, and material strength.

7. The method of claim 5, wherein said outline profile also includes at least one parameter value relating to at least one of thermal conductivity, electrical conductivity, and chemical resistance.

8. The method of claim 5, wherein said outline profile also includes at least one parameter value relating to at least one of thickness, cut pattern, and resistance to corrosion.

9. The method of claim 1, wherein said comparing of methodologies includes identifying one or more bottlenecks with a selected fabrication process and selecting a methodology based on a number of said one or more bottlenecks identified.

10. The method of claim 7, wherein said comparison and selection of said methodology includes identifying one or more re-useability factors.

11. The method of claim 1, wherein determination of applications and calculation of volume of metal by-products depends on material characteristic of a metal used in said main metal product, further comprising selecting a methodology by analyzing historical records relating to type of metal used and data relating to each application.

12. The method of claim 3, further comprising fabricating said metal chips by:
obtaining said outline profile and determining a plurality of fabrication steps using a methodology selected for a fabrication process in said outline profile;
establishing a plurality of checkpoints for monitoring quality of said metal chips during said fabrication process;
selecting at least one metal chip at each of said plurality of checkpoints and measuring said same parameter values as indicated in said outline profile;
comparing measured parameter values with said parameter values in said outline profile and removing said metal chip when said measured parameters fail to meet said parameter values;
determining reason for a failure to match said parameter values at each of said checkpoints and adjusting and/or said fabrication steps and a fabrication tool causing said failure; and
reiterating said fabrication process until a preselected volume of metal chips are fabricated as provided in said outline profile that meet said parameter values specified in said outline profile.

13. The method of claim 12, wherein parameter values in said outline profile that are being monitored are key performance indicators (KPIs).

14. The method of claim 13, further comprising a robotic component into any fabrication tools for monitoring and removal of said metal chips.

15. A computer system for determining re-usability of metal by-products of a main metal product comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
determining a plurality of applications that can be used to manufacture a plurality of metal by-products as part of fabrication of said main metal product;
calculating a size and a quantity of metal by-products needed for each of said plurality of applications and determining at least one fabrication tool needed for their manufacturing;
identifying at least one methodology to be used to fabricate said plurality of metal by-products for each of said plurality of applications based on said size, said quantity and said at least one fabrication tool;
selecting a methodology and related application from a plurality of methodologies and applications identified based on a measure of adherence to factors on a preselected objective list; and
creating an outline profile to be used for fabrication of said metal byproducts based on methodology selected and quantity and size of said metal by-products.

16. The system of claim 15, wherein said metal by-products are a plurality of metal chips and said outline profile is stored in a database, wherein said outline profile includes a selected method for fabrication a volume of said metal chips and a plurality of characteristic parameter values for a final to be fabricated metal chip using said selected method.

17. The system of claim 16, further comprising fabricating said metal chips by:
obtaining said outline profile and determining a plurality of fabrication steps using a methodology selected for a fabrication process in said outline profile;
establishing a plurality of checkpoints for monitoring quality of said metal chips during said fabrication process;
selecting at least one metal chip at each of said plurality of checkpoints and measuring said same parameter values as indicated in said outline profile;
comparing measured parameter values with said parameter values in said outline profile and removing said metal chip when said measured parameters fail to meet said parameter values;
determining reason for a failure to match said parameter values at each of said checkpoints and adjusting and/or said fabrication steps and a fabrication tool causing said failure; and
reiterating said fabrication process until a preselected volume of metal chips are fabricated as provided in said outline profile that meet said parameter values specified in said outline profile.

18. The system of claim 17, further comprising fabricating said metal chips using an AI engine, wherein said AI engine uses said outline profile for fabrication process.

19. A computer program product for determining re-usability of metal by-products prior to fabrication of a main metal product, comprising:
one or more computer-readable storage medium and program instructions stored on at least one of the one or more tangible storage medium, the program instructions executable by a processor, the program instructions comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
determining a plurality of applications that can be used to manufacture a plurality of metal by-products as part of fabrication of said main metal product;
calculating a size and a quantity of metal by-products needed for each of said plurality of applications and determining at least one fabrication tool needed for their manufacturing;
identifying at least one methodology to be used to fabricate said plurality of metal by-products for each of said plurality of applications based on said size, said quantity and said at least one fabrication tool;
selecting a methodology and related application from a plurality of methodologies and applications identified based on a measure of adherence to factors on a preselected objective list; and
creating an outline profile to be used for fabrication of said metal byproducts based on methodology selected and quantity and size of said metal by-products.

20. The computer program product of claim 19, wherein said wherein said outline profile includes a selected method for fabrication a volume of said metal chips, further comprising:
obtaining said outline profile and determining a plurality of fabrication steps using a methodology selected for a fabrication process in said outline profile;
establishing a plurality of checkpoints for monitoring quality of said metal chips during said fabrication process;
selecting at least one metal chip at each of said plurality of checkpoints and measuring said same parameter values as indicated in said outline profile;
comparing measured parameter values with said parameter values in said outline profile and removing said metal chip when said measured parameters fail to meet said parameter values;
determining reason for a failure to match said parameter values at each of said checkpoints and adjusting and/or said fabrication steps and a fabrication tool causing said failure; and
reiterating said fabrication process until a preselected volume of metal chips are fabricated as provided in said outline profile that meet said parameter values specified in said outline profile.
